(19) United States
(12) Patent Application Publication
(10) Pub. No.: US 2013/0160043 A1
(43) Pub. Date: Jun. 20, 2013

(54) SYSTEM AND METHOD FOR IMAGE MATCHING FOR ANALYSIS AND PROCESSING OF A BROADCAST STREAM

(71) Applicants: Mehta Dipankumar, Mumbai (IN); Banker Devendrakumar, Mumbai (IN)

(72) Inventors: Mehta Dipankumar, Mumbai (IN); Banker Devendrakumar, Mumbai (IN)

(73) Assignee: VUBITES INDIA PRIVATE LIMITED, Mumbai (IN)

(21) Appl. No.: 13/700,030

(22) PCT Filed: May 23, 2011
(86) PCT No.: PCT/IN11/00354

§ 371 Date: Feb. 28, 2013

(30) Foreign Application Priority Data
May 24, 2010 (IN) 1602/MUM/2010

(51) Int. Cl. H04N 21/44

(52) U.S. Cl. CPC H04N 21/44008
USPC 725/19

(57) ABSTRACT

A method of image matching of anchor frames with events in broadcast video is developed which can efficiently identify and recognize the broadcast events and at that can be applied for meaningful analysis and or processing of the broadcast video based on the image match technique. The proposed technique relates to frame recognition technique and its utilization in various applications to analyze and process broadcast streams.

### BACKGROUND OF THE INVENTION

1. Field of the Invention

Embodiments of the present invention generally relate to frame recognition technique and its utilization in various applications to analyze and process broadcast streams. The current application demonstrates a splicing operation and the method of on-line schedule verification of a broadcast stream. However, the Image matching technique discussed here is not limited to its application in the said example systems.

2. Description of the Related Art

Various broadcasting stations (e.g., television channels) generate a broadcast stream that includes contents associated with entertainments shows and/or serials, news reporting, conferences and the like. The broadcast stream, as received at remote head-end can be either an analog stream or a digital stream. Generally, broadcasting stations inserts cue tones within the broadcast stream and the broadcast stream is transmitted to a plurality of nearby or remote head ends, where the broadcast stream is processed using the cue tones.

Therefore, there is a need in the art for a system and method for demonstrating a splicing operation and the method of on-line schedule verification of a broadcast stream. However, the image matching technique discussed here is not limited to its application in the said example systems.

### SUMMARY

Various embodiments of the invention comprise a system and a method of Image matching technique for various analysis and processing applications of broadcast streams. In one embodiment the time synchronized splicing operation is demonstrated on a broadcasting stream. In another embodiment, method of on line schedule verification is demonstrated.

Further, the method and system to make images to qualify as anchor frames and finding optimal anchor frame for the event is disclosed. Also, the method for applying the image matching kernel is disclosed.

In another embodiment the system of identifying the event and splicing the stream containing live broadcast is disclosed. In one embodiment, the system includes a broadcasting station for scheduling the splicing operation on the broadcasting stream in accordance to a schedule, and a processing station for performing the splicing operation on the scheduled broadcasting stream in accordance with the one or more events of the schedule.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a communication system in accordance with an embodiment of an invention; and

FIG. 2 illustrates the image matching process.

FIG. 3 illustrates algorithm flowchart for image matching process.

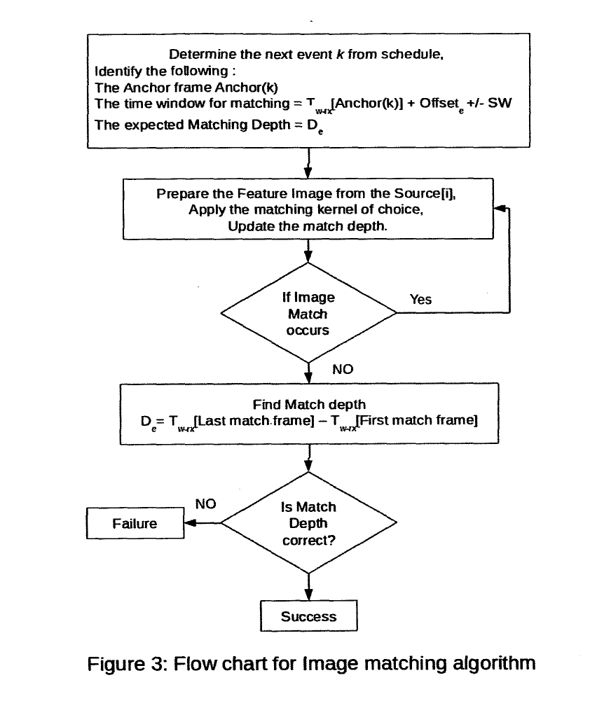

FIG. 4 illustrates a functional block diagram that depicts a schedule verifier in accordance with an embodiment of an invention.

FIG. 5 illustrates algorithm flowchart for channel schedule verification process.

### DETAILED DESCRIPTION

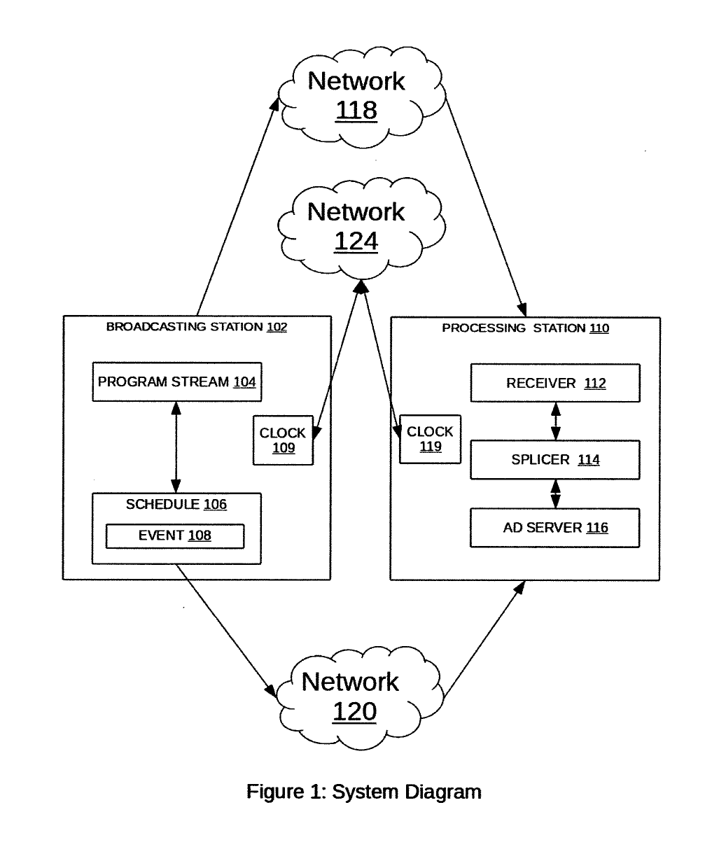

FIG. 1 illustrates a communication system 100 that inserts advertisements in a broadcast stream in accordance with an embodiment of an invention. The communication system 100 includes a broadcasting station 102 and a processing station 110. Generally, the broadcasting station 102 is a television broadcasting station that broadcasts multimedia streams to the processing station 110. In one example, the broadcasting station 102 is configured to broadcast through a network 118. It is appreciated that the communication system 100 can comprise one or more processing stations that are communicably coupled to the broadcasting station 102 through the network 118.

The network 118 comprises a communication system that connects one or more communicable devices such as, the broadcasting station 102, the processing station 110 and/or the like, by a wire, a cable, a fiber optic and/or a wireless link (e.g., a satellite link) facilitated by various types of well-known network elements, such as satellites, hubs, switches, routers, and the like. The network 118 may employ various well-known protocols to communicate information amongst the network resources. For example, the network 118 may be a part of the internet or intranet using various transmission systems such as Broadcast transmission systems, which employs various modulation techniques, various interfaces (e.g., Asynchronous Serial Interface (ASI)), transmission means (e.g., RF cables, Optical fibers, Satellite Links) and/or the like. Alternatively, the network 118 may be a part of an Internet protocol network on Ethernet, Wi-Fi or fiber or dedicated lines, ATM networks etc.

Generally the broadcasting station 102 and a processing station must have a common timebase. This is shared over the network 124. For example the time can be derived through GPS satellite, cellular networks, with protocols like NTP, SNTP and WWV and so on. Alternatively, the broadcasting station can as a primary synchronization source for other processing stations. All such mechanisms are well known in the art and are equally valid for the current scope.

Generally, the broadcast stream 104 is a multimedia stream and includes a video stream having video frames, one or more audio streams having audio frames and an associated data stream having data frames. For example, the broadcast stream 104 includes data related to various programs such as entertaining shows, news, live matches, conferences and/or the like. Also, the broadcast stream 104 includes multiple advertisements that may depict information regarding products and/or services being used by consumers.

The broadcasting station 102 is configured to create a schedule 106 that includes timing related information that is associated with the transmission of various frames of the broadcast stream 104. In one embodiment, the schedule 106 is generated from one or more textual or binary files that include the transmission timings of the frames of the broadcast stream 104.

In one example, the schedule 106 includes timings for transmitting the various frames of the broadcast stream 104 on a particular day. In one embodiment, the schedule 106 includes updated transmission timings of the various frames of the broadcast stream 104. The schedule 106 may also be referred to as play out schedule or on-air schedule.

Further, the schedule 106 includes at least one event such as an event 108 that includes a start time and an end time of a particular time interval. As it will be explained later in the description, the event 108 includes information that enables a splicer 114 of the processing station 110 to replace one or more frames of the broadcast stream 104. In other words, using the event 108, the broadcasting station 102 is configured to communicate the one or more spots to the processing station 110 in order to plan the splicing operation during these spots.

The broadcasting station 102 is configured to transmit the schedule 106 to the processing station 110 via a network 120. The network 120 comprises a communication system that connects computers by wire, cable, fiber optic and/or wireless link facilitated by various types of well-known network elements, such as hubs, switches, routers, and the like. The network 120 may employ various well-known protocols to communicate information amongst the network resources. For example, the network 120 may be a part of the Internet or Intranet using various communications infrastructure such as Ethernet, WiFi, WiMax, General Packet Radio Service (GPRS), and the like.

In one embodiment, the broadcasting station 102 may transmit the schedule 106 to the processing station 110 through the network 118. Optionally, the system may include a scheduling agent (not shown in the figure) that is configured to provide the schedule 106 to the processing station 110. Accordingly, the processing station 110 splices the broadcast stream 104 in accordance with the schedule 106.

The processing station 110 comprises a receiver 112, a splicer 114 and an advertisement server 116. Generally, the processing station 110 is a cable head end that performs operations such as encoding, decoding, splicing, and the like on the broadcast stream 104. In one example, the processing station 110 is located at a location that is remote to the broadcasting station 102. The receiver 112 receives the broadcast stream 104 and accordingly, the splicer 114 utilizes a particular event 108 of the schedule 106 for performing splicing operation on the broadcast stream 104.

Additionally, the broadcast stream 104 reaches at the receiver 112 of the processing station 110 after a finite amount of time. This delay in arrival of the broadcast stream 104 is due to propagation through a communication channel (e.g., the network 118). Such delay is known as a channel delay and this delay may remain constant for a particular communication channel. Further this channel delay is considered by the splicer 114 during splicing operation in order to have accurate splicing.

In one embodiment the splicer 114 does not use the typical cue tones during the splicing operations. The splicer 114 may be a frame accurate splicer or any other splicer that is well known to a person skilled in the art. The splicer 114 utilizes the event 108 of the schedule 106 to detect the splice in point and the splice out point. Further, the timings of the splice in point and the splice out point are in accordance with wall clock timings. In one embodiment, the broadcasting station 102 and the processing station 110 may use time references such as, global positioning system (GPS) clock.

Any event transmitted from broadcast station reaches the processing station exactly in a specified amount of delay, this is known as channel delay, referred to here as, T_{cd}. The value of T_{cd} is unique for a unique transmission path in the communication channel and T_{cd} may remain constant over a long term.

Dispatching the Presentation Schedule and On-Air Schedules & Changes

Further, the schedule 106 (e.g., on-air schedules or presentation schedule) is generally spread across one or more text or binary files and as mentioned earlier, the schedule 106 is transmitted to processing station 110 over any file transfer network (e.g., network 118, network 120). Also, the arrival time of the schedule 106 plays no role in deciding the splicing operation as long as the schedule 106 is available in well advance at the processing station 110. As the splicer 114 is aware of the on-air schedule, therefore, in one embodiment, the splicer 114 may wake up on its own for finalizing the decisions of which advertisements to play, and begin the splicing operation. As a result, the processing station 110 does not require any pre-roll (other than the schedule 106) as required by other processing stations that are based on cue-tone centric architecture.

Further, as the advertisement server 116 is aware of the schedule 106 in advance, (i.e., exact time and accurate duration is well known to advertisement server 116 prior to the arrival of the splice in point), advertisement server 116 is configured to select an advertisement that optimally suits the time and duration being provided by the schedule 106.

In one embodiment, the splicer 114 communicates with the advertisement server 116 for the replacement audio or video frames. Additionally, the broadcasting station 102 is configured to transmit the updated schedule 106 to the processing station 110. The updated schedule 106 may includes one or more updated events 108. Accordingly, the processing station 110 receives the updated schedule 106 and the splicer 114 identifies updated splicing points. At last, the broadcast stream 104 is spliced in accordance with the updated schedule 106.

The schedule verifier determines whether the play out schedule is in accordance with the original schedule. As such, mismatch in the play out schedule and original schedule may occur when the updated schedule is not communicated to the head ends. Such error in communication may occur due to transmission or connectivity failure. As it will be explained later in the description that the schedule verifier determines the mismatch by using algorithm.

Splicing of in the Presence of Live Events

Generally in broadcast streams, live streams such as news, sports etc. may exists. Such live events may not have fixed duration since the completion of event is decided by human intervention etc. Hence, after the live event finishes, the schedule will typically not follow the original on-air time as per schedules but will be shifted by an unknown amount. In some cases, an amendment schedule can be resend to all processing stations such that subsequent events can be spliced appropriately.

However, in some cases, such as news and sports, the frequency of live streams can be much higher and there may not be enough time to re-distribute the updated schedule to all processing stations. Hence, new mechanism needs to be devised.

Let say, Broadcast has planned events Event[0] to Event[n] which are expected to follow the same said sequence. To simplify but not as a limitation of the method, let say, the Event[i] has a variable duration. Hence, all events after Event[i] will have a modified start time. Let us assume that Anchor frame for Event[i+1] is available.

Hence, arrival time of the event Event[i+1] is captured based on the image matching technique as described in subsequent sections. Based on modified arrival time of Event[i+1], denoted as T_{w-rx′}[eᵢ₊₁], is known.

Since, Event[i+1] and all subsequent events has fixed duration, the new arrival time of each events T_{w-rx′}[eᵢ₊ₖ] can be computed and used for accurate splice point.

Automation of Tracking and Detecting On-Air Schedules

Quite often over a full day of broadcasting the schedule 106 does not remain static in nature. The schedule 106 changes as per requirements of the broadcasting station 102. These changes in the schedule 106 needs to be synchronized with the processing station 110. Thus, the present invention discloses a method that allows the processing stations 110 remain self aware that schedule 106 is as per the original track or is it disturbed.

Further, when a local spot are declared with the original time of schedule—the new time for those spot after schedule changes needs to be determined. The mechanism of schedule verifier uses similar principles of automated delay calibration.

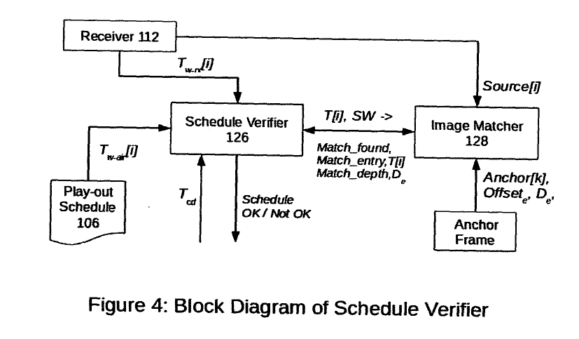

FIG. 4 illustrates the process of automated schedule verification.

In this method, the arrival of anchor frames is tracked at the processing station 110. Assuming that the channel delay T_{cd} is known for an established system and current schedule is available, and also the images of the anchor frames are a prior extracted. The anchor frames arrival is detected using image matching of pre-stored anchor frame and the one derived from the received broadcast stream.

The schedule verifier 126 selects the next event E for which the Anchor[E] is available. Let say, an event E is expected to start at T_{w-air}[E₀]. Let say that Anchor frame of event E, Anchor[E] is at some time after the one at the start. Given the value of the channel delay T_{cd}, the said anchor frame is expected to arrive at the processing station at

T_{w-rx}[Anchorₑ]=T_{w-air}[Anchorₑ]=T_{cd}=T_{w-air}[E]+δₑ+T_{cd} T_{w-rx}[Anchorₑ]. Equation 12

Hence, after identifying the next anchor frames, the schedule verifier 126, initiates the image matcher 128 for the process of matching the Anchor[E] frame with in the period, T_{w-air}[Anchorₑ]±SW. If the match is NOT found, within the search range specified, the schedule is out of track.

However, if the match does indicate presence of the anchor frame within the given window, the match process continues till T_{w-air}[Anchorₑ]+Duration[e]+T_{cd}, i.e. the end of the sequence. If the match repeats again, the said sequence doesn't qualify for the event arrival to be successful.

The rational for extended match is that the said Anchor frames are usually unique across vast amount of other broadcast data; and definitely must be unique for the content of the given event. If an anchor is expected be repeat at least once after the first appearance within the same event, than it cannot be distinguished whether the first observed arrival indeed correlates to the first arrival as expected in the event.

If the first match is successful and if there is no other match during the duration, the arrival time of the matched anchor frame at the receiver 112 is compared with the theoretical arrival time of the same anchor frame if the hypothesis below,than the schedule is said to be stable.

T_{w-rx}[MatchedAnchorₑ]=T_{w-air}[Anchorₑ]+δ[e]+T_{cd} Equation 13

The matching algorithm needs to run only for a certain time window as listed above. The resolution at which schedule verification can be confirmed is dependent on the availability of the number of identifiable anchor frames.

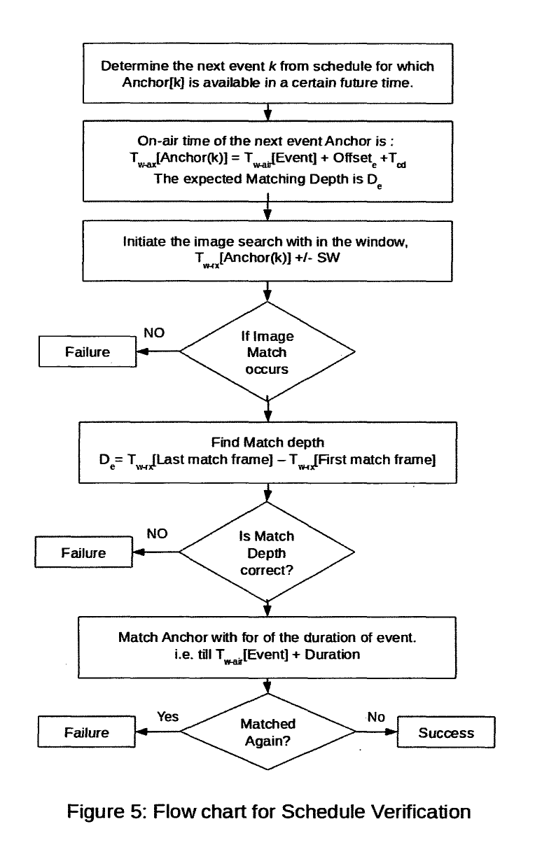

FIG. 5 illustrates the process of on line schedule verification through a flow chart.

Schedule verification can be done by any “master” processing station or by every critical processing station depending on application at hand.

When the schedule 106 is updated and is communicated to the processing station 110, it is possible that a particular event may have modified timings. This is determined by locating the identification (ID) of the particular event.

Automation of Generating the Anchor Frame

As described earlier, schedule tracking is done using anchor frames which are assumed to be known a prior to the processing station. Anchor frame generation requires a one time solution however as new content starts flowing in broadcast then new anchor frames corresponding to the new content are required progressively.

Automatic extraction of Anchor frames is possible only if following conditions are met:

1. Channel delay for a given path is known.

2. Any 2 seed anchor frame is known and expected to be visible in the upcoming transmission.

3. Schedule is available and is known to be locked/stable during the period of experiment. Also, that it doesn't expect to contain any live event.

We assume that at least two anchor frame is available (manually) to start the operation. However, further anchor frames can be extracted automatically using the following method.

These anchor points are part of some event 108. As discussed earlier, tracking of the schedule 106 identifies whether the schedule 106 was on track between two given anchor points. When it is identified that the schedule is tracked between two events, it means that all other events between the two events were also following the same schedule accurately. To confirm whether indeed the schedules were followed during the two anchor points, can guaranteed by the logs of the broadcasting station.

Following method can be used to extract anchor images from the said events.

Let say, an event E₀ and Eₙ is identified to be on time to start at T_{w-air}[E₀] and T_{w-air}[Eₙ], with intermediate events T_{w-air}[Eᵢ] between them. The arrival time of each of these events can be predicted based on equation 1.

T_{w-rx}[Eᵢ]=T_{w-air}[Eᵢ]+T_{cd} Equation 14

All unique frames, which best qualifies the above criteria as listed in the subsequent sections can be considered as an anchor frame, which arrives at the time of T_{w-rx}[Eᵢ]. After the event is passed, system can verify whether indeed event Eᵢ and all events between E₀ to Eᵢ was transmitted as per schedule.

As a result, specific frames extracted at the times of the scheduled times of the events will serve as the anchor frames of those events.

Image Matching

As discussed earlier, image matching is used for three purposes—identifying the arrival time of images after live events, calculation of channel delay and schedule verification. In order to use correct image matching, algorithms having the following properties are used.

A) Algorithm matches positive in spite of typical encoding noise and channel noise.

B) Algorithm detects mismatch due-to small movements or change of colors.

C) Content matched and identified should be reasonably unique such that it can be used for dependable inference about actual broadcast.

The present invention proposes the following algorithm having aforementioned attributes:

Overview of the Matching Process:

Any matching process starts and ends within a search window called SW.

For the event e, the incoming stream is a sequence of images called Sourceₑ[i], and the target anchor picture is known as Anchorₑ.

The first frame in the source matches with the anchor frame at a frame k, is called Sourceₑ[k] known as “Match entry”, and the time at which matching starts is called “match time”. This is referred as T_{w-rx′}[Matchₑ] which can be treated as the actual arrival time of the Anchor Frame, which is same as T_{w-rx}[Anchorₑ].

In some cases, the most characterizing frame that can uniquely identify the given video event, may not start at the very first frame but it can be somewhere in between. This is considered as a match-offset usually referred as Offsetₑ

Based on this, when correct event is transmitted on time, for which the anchor frame is available, the match is expected as follows,

@T_{w-rx}[Matchₑ]=T_{w-rx}[Eventₑ]+Offsetₑ:Anchorₑmatches□ Sourceₑ[k] Equation 15

Matching Depth

In a typical video sequence when a scene arrives, is static for a while, say a few seconds or so, such that human eye can recognize it. The scene may remain static for one second to a few tens of seconds. Hence, given a good anchor frame, when matched against such a video sequence, match will occur for all those frames which are part of the scene over a duration. Such a duration where match continually succeeds, is called as “match depth” denoted as Dₑ. We can then express this in the following way:

@T_{w-rx}[Matchₑ]=T_{w-rx}[Eventₑ]+Offsetₑ:Anchorₑ matches□ □ [symbol] urceₑ[k] . . . Sourceₑ[k+Dₑ] [symbol] Equation 16

Matching depth of an Anchorₑ on a given Event video sequence is Dₑ only if the match occurs between all frames of Sourceₑ[0]□ Sourceₑ[Dₑ]]and Sourceₑ[Dₑ□1] does not match.

Matching depth of an Anchorₑ on a given Event video sequence at Offsetₑ is signature characteristic of event as it helps uniquely identify the event video. For example, If the Anchor frame matches the given source sequence starting from exact offset, but matching depth varies significantly compared to the original sequence, it implies that while, few pictures of the event sequence is same, quite a few has been modified. This could be a case, when source event could be a modified or edited version of the intended sequence but not frame identical.

In general, larger the Matching depth, it is better because during this time scene features are reasonably static and hence free from effect of noise, rapid transitions etc. which has higher chances of false matches or mismatches.

FIG. 6 illustrates the image matching process in the form of time line.

Criteria for the Selection of Anchor Image

As stated earlier, the inference derived about the sanity of whether events were at correct timings in the broadcast, depends on how uniquely, does an Anchor frame maps to the given event. Hence, selection of key anchor frames has a direct impact on the efficacy of system's performance. Following criteria are set to ensure that meaningful anchor frame is selected for all processing.
1. The candidate anchor frame should not be part of any transition effect of editing between any two different events/content programms.
2. The candidate anchor frame must have certain minimum energy level and a minimum spread of color/intensity variation. For e.g. pure black or pure white frames or with any dominant colors etc. are invalid anchor frames. To quantify this, we can define a criteria in the following way. Any image has intensity of any color plane or gray scale plane represented as pixel values between 0-255 (or any number N). The image is vector quantized to find dominant intensity clusters as visible in the image. If any cluster formed is larger than 50%, we can identify that the picture has a dominant color or texture and hence it is not suitable for being the anchor frame.
3. If the given anchor frame matches any other anchor frame with the given pool, both the matching anchor frames are essentially disqualifies because both would be likely to match at the same time in all relevant events.
4. Matching depth of the given anchor at given offset on the event video sequence must be higher than a minimum threshold value. if the anchor flicks only as a one or two frames it may have severe transition effects and might generate many false negatives
5. If the given anchor image matches within the given event sequence, more than once, than the anchor image is not valid. For example, if the video sequence is 30 second long, and the selected anchor image matches between 1 to 2 second duration initially and later the same anchor image also matches between say 27 to 28 second duration, such a frame is not a valid anchor frame.
6. The ideal candidate for anchor frame of the given event is the one which has the highest Matching depth (assuming that it meats the above criteria). The algorithm below explains the same. This is also true empirically because it constitutes largest portion of the video sequence.

[symbol]

Creating the Feature Image

Before the image is matched against the anchor it undergoes several processing to ensure that matching is reliable and not been affected by noisy factors. One or many of these steps can be followed to produce the right feature image from the input sequence.
a. Resolution scaling: the picture size is appropriately scaled to ensure that correct pixels overlap while matching.
b. Rol mapping: In many cases, the source image is overlapped with animated logs, banners; it may contain letter box for aspect ratio conversion etc. In such cases, pixels that do not belong to original source image may adversely contribute to matching process and increases the rate of failure. Such overlay contents truely doesn't belong to the intended events, hence the image is cropped with appropriate size on all boundaries to ensure that only those pixels are being responsible which actually belong to the said event. This, region is called as Region of Interest, for the given image.
c. Filtering: low pass filtering is applied on the image to remove noise, sharp edges and small details. The processing should emphasis on the broader macro structure of the image and deemphasis finer textural variations which are very local in parts of the image. The filter should also try to nullify the effect of blockiness of MPEG noise and false edges created by it.
d. Filtering for the Anchor frame: Anchor frame of a given image can be smoothed by a unique filtering methods. Since events with anchor frames might be repeated over time, and they may also be visible across, many processing stations, it is possible to capture multiple instances of the same anchor image and combine the image (averaging it) to produce a virtually noise free image without having to loose critical information which a general low pass filtering tend to loose.
e. Temporal Averaging of Anchor frame. In many occasions, when the anchor frame matches the portion of the video is moderately static but has finer motion. In such cases, motion disrupts the matching process. To circumvent the situation, we can collect all the frames which are matching subsequent to each other. i.e. with in the source image, every frame Source[i] matches with Source[i+1], till Dₑ where matching fails any further. Based on this, we can generate

$$Anchor [ k ] = \frac{1}{{D}_{e}} \sum Source [ i ] \qquad Equation 17$$

Such image captures finer temporal motion from entire scene and hence provides higher matching depth compared to anchor frame which is the same as 1^{st} frame of the sequence namely Source[0].

The Matching Kernel

In one embodiment, the feature images processed as described above, is applied for matching to identify whether they are similar in some nature or not. These images are applied to find the distance between them through an algorithm called matching kernel.

The listed below matching methods are only some examples of how such matching can be done. There can be many more methods and matching kernels could exist.

1. Minimum Mean Square Error

MMSE[i]=log [symbol] [symbol] urce[i][x][y]−Anchor[k][x][y]

[symbol]

MMSE[i]=2□ log [symbol] [symbol] ource[i][x][y]−Anchor[k][x][y]

[symbol]

if [symbol] MSE[i]>θₑᵣᵣ□ Equation 18
Match is successful.

This algorithm compares the mean square error between two pixels as follows:

PixelMatch[x][y]=TRUE: if [symbol] urce[i][x][y]−Anchor[k][x][y] [symbol] θₚᵢₓₑₗ

PixelMatchCount=ΣPixelMatch[x][y]

if [symbol] ixelMatchCount [symbol] ageWidth□ImageHeight [symbol] θ_{count}□ Equation 19
Match is successful.

2. Per Pixel Classification

3. Block Matching in DCT Domain

In many cases—the video sequences are available in MPEG format which are encoded using DCT co-efficients. In this case, each image is divided as sub image of—8×8 blocks. Accordingly, the error equivalent of MMSE can also be calculated in DCT domain itself. Further, since the DCT of the inter-frame difference is same as difference of DCT of individual image, a percentage of number of blocks being matched can be determined. Also, if number of matches is above a specific threshold, then it is concluded that images are matched.

DCTMatch[b][c]=TRUE: if [symbol] urce[i][b][c]−Anchor[k][b][c] [symbol] θₚᵢₓₑₗ Equation 20

where b corresponds to number of DCT blocks in the image, and c is co-efficient count.

DCTMatchCount=ΣDCTMatch[b][c]

if [symbol] CTMatchCount [symbol] ageWidth□ImageHeight [symbol] θ_{dct} [symbol] Equation 21
Match is successful.

For 8×8 system, the range of c is 0 to 64. However, many higher frequency co-efficients are not used and practically matching can be restricted for c between 0 to 10 or so. In case of DCT based matching, filtering is not separately applied, but the above truncation of higher frequency range does the job of filtering.

4. Image Matching in Hardware for Analog Signal

If there is a hardware based device performing splicing of an analog signal, a corresponding image matching can be achieved in this hardware device. It is assumed that this hardware device include a memory buffer that is used as image buffer. Further, when the processing station 110 receives a horizontal line of a video, this horizontal line is sampled and digitized. The received horizontal line is compared with the corresponding horizontal line of the image buffer and thereafter the difference is calculated. This comparison is done by a simple subtracting circuit followed by an accumulator that will indicate the energy of each output signal. Further, a suitable threshold is then selected to determine if the images are matched.

Summarizing the Image Matching Process:

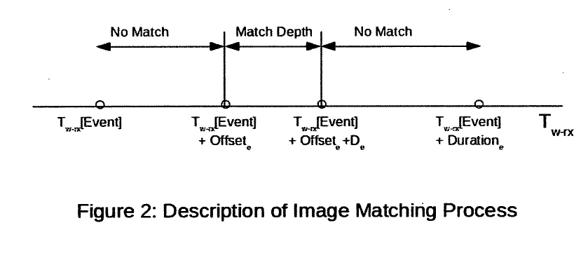

The above principles are summarized as an algorithmic process of performing image matching, under the FIG. 2. Accordingly, the system starts identifying the required event and its corresponding anchor frame k.

The process of matching starts with a given window of time where event is expected to arrive along with a search window. Also, we can identify the offset and the matching depth of that anchor frame on that event.

Based on this every subsequent picture from the source is first transformed into a feature image. The anchor image is already transformed once into a feature image. Once, the feature images are available, the images are applied against the image kernel and evaluated if the kernel declares the images to be matching.

If the frames do match, the process continues till any further match is available. Once, the matching is over. the matching depth is computed. If the matching depth the current experiment is same within the expected range of per-known matching depth of the anchor frame, than the event is said to be successfully matched. where as if the match depth doesn't match, than the events are said to be non matching.

Accordingly, the method proposed here for splicing, automatic tracking of schedules and similarly many such derived applications where identifying of event or content based on recognition can be accomplished. Many other applications such as broadcast health monitoring, verification of splicing operation, and so on can take advantage of visual verification which is otherwise only possible through human observation.

The critical advantage of such a system is that it relies only on the real video sequence to identify events such that it can be at par with human observation and could be much more efficient.

Another aspect is that such a method can work irrespective of media type, mode of transport such as analog, digital etc., and different transmission variants; hence the techniques such as this can be applied for a broad range of applications in critical broadcast operations.

Another advantage of the said method is that the reference image, which is anchor image, is only one image where as it matches with several combinations in the video. At a time only one image match is required and hence the method requires relatively much smaller memory as well as the smaller number of image match permutations compared to a method where anchor references would also be video segments themselves.

While the foregoing is directed to embodiments of the present invention, other and further embodiments of the invention may be devised without departing from the basic scope thereof.

1. A method of identifying events in a broadcast video by matching against an anchor frame comprising:
determining an expected time of arrival of an event and a matching depth of the anchor frame.

2. The method of claim 1 further comprising determining the matching depth of a given anchor on a broadcast event.

3. The method of claim 1 further comprising identifying whether the frame can be used as an anchor frame or not.

4. The method of claim 1 further comprising searching most effective anchor frame given the broadcast event.

5. The method of claim 1 comprising generating the anchor frames automatically based on scheduled time available.

6. The method of claim 1 further comprising applying image matching that comprises of generating feature frames, and matching kernel to perform matching.

7. The method of claim 6, wherein matching comprises matching individual features images using different image matching kernels such as
MMSE where magnitude of the error difference being less than a threshold defines the match; and
Pixel count based method, where count of number of pixels which are closer to corresponding image defines match;
DCT based method where count of number of DCT co-efficients matching between the images define the match of image.

8. A system for identifying events in a broadcast video by matching against an anchor frame comprising a module for determining an expected time of arrival of an event and a matching depth of the anchor frame.
